(19) United States
(12) Patent Application Publication
(10) Pub. No.: US 2005/0086270 A1
(43) Pub. Date: Apr. 21, 2005

(54) Update notifying apparatus, update notifying method, and program therefor

(75) Inventors: Tomoyuki Shimizu, Kanagawa (JP); Hiroyuki Nagai, Tokyo (JP)

Correspondence Address: ROSSI & ASSOCIATES, P.O. BOX 826, ASHBURN, VA, 20146-0826, US

(73) Assignee: CANON KABUSHIKI KAISHA

(21) Appl. No.: 10/822,342

(22) Filed: Apr. 12, 2004

(30) Foreign Application Priority Data
Apr. 11, 2003 (JP) 2003-107834

(51) Int. Cl. G06F 17/30

(52) U.S. Cl. 707/200

(57) ABSTRACT

There is provided an update notifying apparatus which makes it possible to solve the problem that a notifying time lag occurs when a plurality of data files are frequently transmitted and the problem that the frequent transmission of data files makes it difficult to grasp contents of notification. Update of a data is detected. An update content which indicates a difference between the data before and after the update is stored. A plurality of update contents stored in the storing step is notified in a predetermined form.

### BACKGROUND OF THE INVENTION

1. Field of the Invention

The present invention relates to an update notifying apparatus, an update notifying method, and a program therefor, and more particularly to an update notifying apparatus, an update notifying method, and a program therefor, for monitoring update of electronic data and notifying the update.

2. Description of the Related Art

In recent years, the widespread use of computers has enabled generation and publication of numerous electronic documents. However, when an electronic document is updated e.g. by modification thereof, a user who wants to recognize the updated portions of the document has conventionally had to carry out an operation for causing the document to be displayed so as to view differences from the preceding version of the document used on the immediately preceding occasion.

In the situation described above, recently, an update notifying apparatus disclosed in Japanese Laid-Open Patent Publication (Kokai) No. H10-171700 has attracted public attention. This update notifying apparatus intermittently monitors presence of a data file, such as an electronic document, and modification or change of a content thereof to thereby detect update of the data file and notify an apparatus user (hereinafter referred to as the “notified party”) of the data update.

Many of conventional update notifying apparatuses including the above-mentioned apparatus notify the notified party of data update on immediately upon detection of the same, to thereby meet the demand of users or notified parties who desire to be informed of update of data as soon as possible. The immediate or real-time notification is effectively utilized e.g. in tracking updates of pages of a stock list open to the public on the Internet or detecting some malicious person's tampering of data on a machine managed by a user.

However, when data is frequently updated, or when many of updated portions are not interesting to a user or notified party, the notified party sometimes wishes to be notified of a certain number of updates in a complied form, instead of being notified immediately.

The notified party cannot always check updated contents, and therefore when an updated content happens to be overlooked, the notified party needs to view saved past information, thereby checking the missed updated content. This operation is troublesome particularly when a small-sized terminal device with a low throughput is used. Further, pieces of update information of many data files are sent in a mixed manner, which makes it difficult to track updates of a single data file. For example, when information of stock prices and many other pieces of information, such as information of a game or a match still in progress, are sent in a mixed manner, the notified party has to track updates of data files by selecting necessary information on his terminal device. Further, whenever an update of a data file is detected, the data update is notified, which causes an increase in traffic of the network.

To solve the problems, there has been disclosed an update notifying method by Japanese Laid-Open Patent Publication (Kokai) No. H11-120190, which comprises storing several updates having taken place in a database within a predetermine time period, and then batch-processing the stored updates after the lapse of the predetermine time period, followed by notifying the results of the processing.

However, this method suffers from the following problems:

First, in this method, the batch processing (retrieval) is executed for notification, and therefore e.g. when updates are frequently searched, processing load increases and it takes much time before notification. For example, when a desired notifying time is set by the notified party, it is difficult to notify the notified party at the desired notifying time or a time close thereto due to a time lag caused by the processing. Further, the method is only for notification of the result of a search reserved in advance, and therefore it can be used to know whether or not there is a change in contents of a database, but Japanese Laid-Open Patent Publication (Kokai) No. H11-120190 does not described a specific method of notifying updates of contents in the compiled form.

### SUMMARY OF THE INVENTION

It is an object of the present invention to provide an update notifying apparatus, an update notifying method, and a program therefor, which make it possible to solve the problem that a notifying time lag occurs when a plurality of data files are frequently transmitted and the problem that the frequent transmission of data files makes it difficult to grasp contents of notification.

To attain the above object, in a first aspect of the present invention, there is provided a method of notifying updates of data, comprising a detecting step of detecting update of data, a storing step of storing an update content which indicates a difference between the data before and after the update, a notifying step of notifying a plurality of update contents stored in the storing step in a predetermined form.

With the arrangement of this update notifying apparatus, it is possible to solve the problem that a notifying time lag occurs when a plurality of data files are frequently transmitted and the problem that the frequent transmission of data files makes it difficult to grasp the notification content.

Preferably, the notifying step comprises notifying the plurality of update contents in a form arranged in order in which the update of the data is detected.

Preferably, the notifying step comprises notifying the plurality of update contents stored in the storing step after notifying last time.

Preferably, the update content includes at least states before and after update of updated part of the data.

Preferably, the storing step comprises storing the update content in a case where the update satisfies a predetermined criterion.

Preferably, timing for notification in the notifying step is externally designated.

Preferably, timing for notification in the notifying step is scheduled in advance.

Preferably, the method further comprises an update criterion-setting step of setting an update criterion to be applied in notifying a notified party of the updated contents, and an extracting step of extracting a portion of latest updated data satisfying the update criterion set in the update criterion-setting step, as the updated content.

To attain the above object, in a second aspect of the present invention, there is provided a method of notifying updates of data, comprising a detecting step of detecting update of data, a notifying step of notifying an update content which indicates a difference between updated data detected in the detecting step and data obtained from storing means, a storing step of storing at least the updated data corresponding to the update content notified last time in the notifying step in the storing means, wherein the notifying step comprises notifying an update content which indicates a difference between the updated data detected in the detecting step and the updated data stored in the storing step.

To attain the above object, in a third aspect of the present invention, there is provided an update notifying apparatus comprising a detecting device that detects update of data, a storing device that stores an update content which indicates a difference between the data before and after the update, a notifying device that notifies a plurality of update contents stored in the storing step in a predetermined form.

To attain the above object, in a fourth aspect of the present invention, there is provided an update notifying apparatus comprising a detecting means for detecting update of data, a storing means for storing an update content which indicates a difference between the data before and after the update, a notifying means for notifying a plurality of update contents stored in the storing step in a predetermined form.

To attain the above object, in a fifth aspect of the present invention, there is provided a program for causing a computer to execute an update notifying method, comprising a detecting module for detecting update of data, a storing module for storing an update content which indicates a difference between the data before and after update, a notifying module for notifying a plurality of update contents stored in the storing step in a predetermined form.

The above and other objects, features, and advantages of the invention will become more apparent from the following detailed description taken in conjunction with the following drawings.

### BRIEF DESCRIPTION OF THE DRAWINGS

FIG. 1 is a block diagram showing the basic arrangement of an update notifying apparatus according to a first embodiment of the present invention;

FIG. 2 is a block diagram showing the circuit configuration of the update notifying apparatus in FIG. 1;

FIG. 3 is a flowchart showing an update notification content-generating process executed by the update notifying apparatus;

FIG. 4 is a flowchart showing an update notification content-notifying process executed by the update notifying apparatus;

FIG. 5 is a diagram useful in explaining the structure of data stored in a notification target data storage section appearing in FIG. 1;

FIG. 6 is a diagram useful in explaining the structure of data stored in a time-series data storage section appearing in FIG. 1;

FIGS. 7A to 7D are diagrams useful in explaining a detection and extraction of an updated content extraction carried out by the update notifying apparatus;

FIGS. 8A and 8B are diagrams useful in explaining modifications in a notification target data file the update of which is to be notified by the update notifying apparatus;

FIG. 9 is a diagram useful in explaining an example of extraction of the updated content carried out by the update notifying apparatus;

FIG. 10 is a diagram showing an example of a notification content notified by the update notifying apparatus;

FIG. 11 is a flowchart showing a variation of the update notification content-generating process executed by the update notifying apparatus;

FIG. 12 is a flowchart showing a variation of the update notification content-notifying process executed by the update notifying apparatus;

FIG. 13 is a diagram useful in explaining a variation of the structure of data stored in the time-series data storage section apparatus in FIG. 1;

FIG. 14 is a diagram useful in explaining an example of a variation of extraction of the updated content carried out by the update notifying apparatus;

FIG. 15 is a block diagram showing the basic arrangement of an update notifying apparatus according to a second embodiment of the present invention;

FIGS. 16Aa and 18Ab are flowchart showing an update notification content-generating process executed by the update notifying apparatus in FIG. 15;

FIG. 16B is a flowchart showing an update notification content-notifying process executed by the update notifying apparatus;

FIG. 17 is a diagram showing an example of a notification content in a method (addition mode) executed by the update notifying apparatus, in which updated contents between the immediately preceding notification and the present notification are stored in an added manner;

FIG. 18 is a block diagram showing the basic arrangement of one form of an update notifying apparatus according to a third embodiment of the present invention;

FIG. 19 is a block diagram showing the basic arrangement of the other form of the update notifying apparatus according to the third embodiment; and

FIG. 20 is a block diagram showing the basic arrangement of a communication system including the update notifying apparatus in FIG. 18 or 19.

### DETAILED DESCRIPTION OF THE PREFERRED EMBODIMENTS

The present invention will now be described in detail below with reference to the drawings showing preferred embodiments thereof.

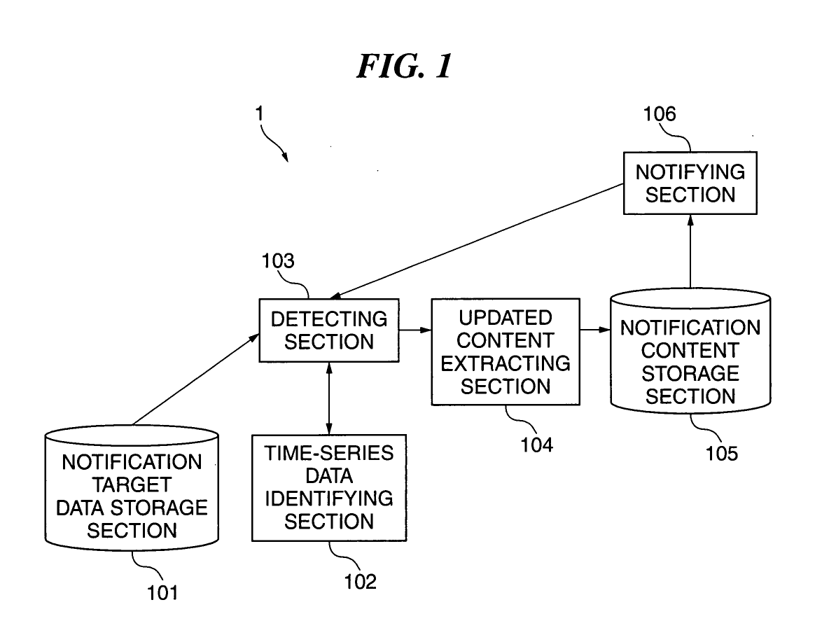

First, a description will be given of a first embodiment of the present invention with reference to FIGS. 1 to 10.

FIG. 1 is a block diagram showing the basic arrangement of an update notifying apparatus according to the first embodiment.

As shown in FIG. 1, the update notifying apparatus 1 is comprised of a notification target data storage section 101 that acquires a target data file the update of which is to be notified and past data files (time-series data files) thereof to manage and store these files, and recognizes a modification in the notification target data file, a time-series data identifying section 102 that manages information necessary for extracting a proper one of the past data files stored in the notification target data storage section 101, a detecting section 103 that compares two data files and determines (hereinafter, simply referred to as “detects”) whether or not a modification of the notification target data file satisfies a particular criterion (update criterion), an updated content extracting section 104 that extracts a content of the modification which is determined to satisfy the criterion, i.e. detected by the detecting section 103 (hereinafter, simply referred to as an “updated content”), a notification content storage section 105 that stores updated contents extracted by the updated content extracting section 104, in a form compiled as information for notification (hereinafter simply referred to as an “update notification content”), and a notifying section 106 that notifies the notification content stored in the notification content storage section 105 to an apparatus user to whom the update notifying apparatus 1 sends the update notification content (hereinafter referred to as “the notified party”).

The notification target data storage section 101 may manage acquisition of the notification target data file and the past data files of the notification target data file e.g. based on time information. Further, the modification to be recognized by the section 101 is not necessarily limited to a content modification to be notified by the present apparatus, but even in notifying a modification of a text portion of a document data file, for example, the section 101 may recognize a modification of a diagram or a table.

Further, when the notification target data storage section 101 manages notification target data files based on time information as described above, the time-series data identifying section 102 manages the time information as information for identifying each of the data files.

Assuming that the criterion based on which the detecting section 103 carries out the detection on two HTML documents is “whether or not a text portion except HTML tags has been modified (added, updated, or deleted)?”, and if any character string other than the HTML tags has been modified (added, updated, or deleted), the detecting section 103 determines that a modification satisfying the criterion has been made. The criterion for the detection is not limited to the above example, but any desired criterion suited to a notification target data file or complying with the request of the notified party may be used. Further, the use of a single criterion is not limitative, but there may be employed a plurality of criteria.

The update notification content has only to be data formed by compiling one or more updated contents of at least one notification target data file, for notification. Further, when there are a plurality of notified parties, updated contents may be compiled on a notified party-by-notified party basis, to form an update notification content for each notified party.

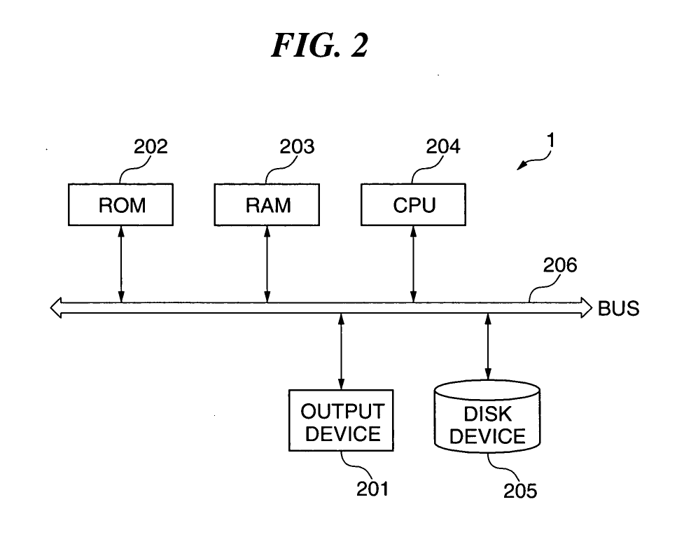

FIG. 2 is a block diagram showing the circuit configuration of the update notifying apparatus 1 shown in FIG. 1.

In FIG. 2, the update notifying apparatus 1 is comprised of an output device 201 implemented by a display and/or loudspeakers, for outputting a notification content to the notified party, a ROM (Read Only Memory) 202 as a memory storing programs to be executed by the update notifying apparatus 1, a RAM (Random Access Memory) 203 as a work memory used as a work area for executing the programs stored in the ROM 202, a CPU (Central Processing Unit) 204 that executes the programs stored in the ROM 202, a disk device 205 implemented by a hard disk drive (HDD) or the like which is capable of adding and erasing data, such as notification target data stored in the notification target data storage section 101 and a notification content stored in the notification content storage section 105, and a bus 206 interconnecting these sections of the update notifying apparatus 1 so as to enable data exchange therebetween.

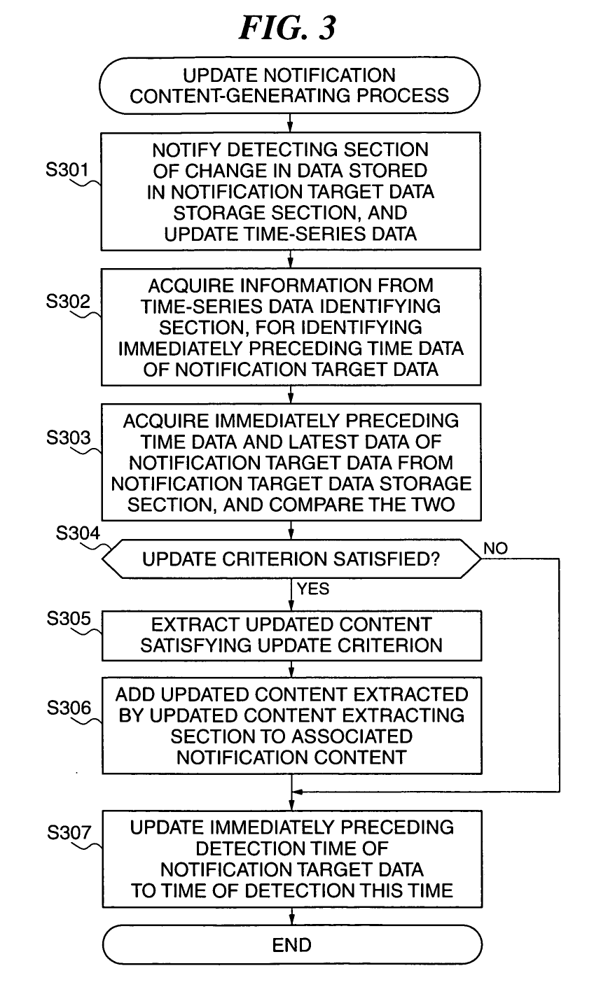

FIG. 3 is a flowchart showing a notification content-generating process carried out by the update notifying apparatus 1 in FIG. 1. This process is executed by the CPU 204 according to a control program stored in the ROM 202.

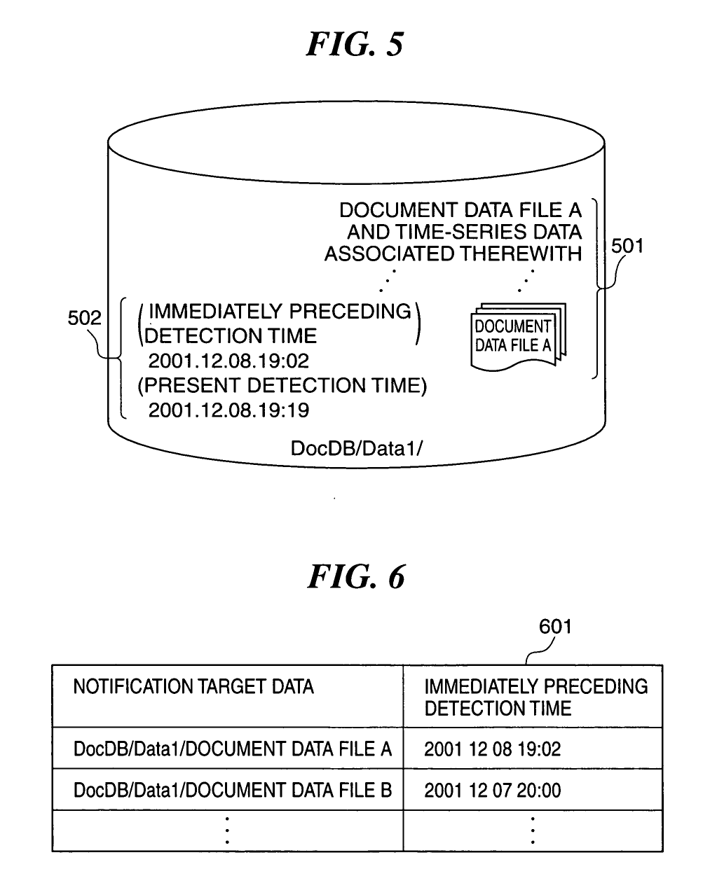

In FIG. 3, first, in a step S301, the notification target data storage section 101 notifies the detecting section 103 that a notification target data file stored in the notification target data storage section 101 has been modified, and then updates time-series data also stored therein. In the present embodiment, it is assumed that the notification target data storage section 101 stores a document data file A and time-series data 501 or preceding versions of the document data file A, as the notification target data, as shown in FIG. 5, and when a new document data file A is acquired, the section 101 detects that the notification target data file has been changed, and updates the time-series data 501 using detection time information 502 therefor.

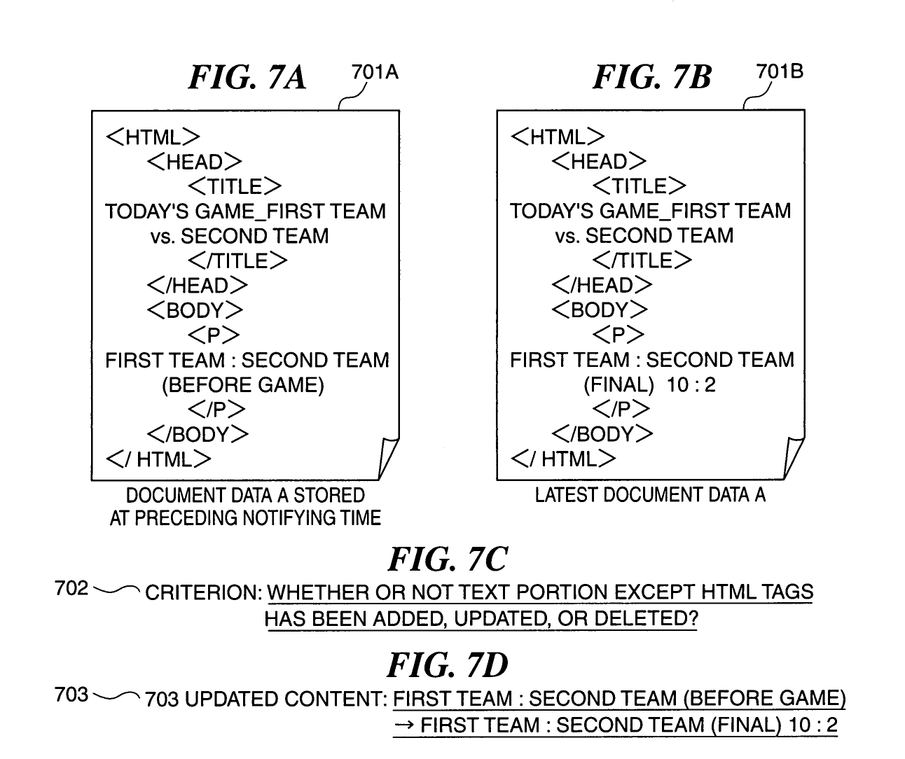

Then, in a step S302, the detecting section 103, upon being notified of the modification in the document data file A by the notification target data storage section 101, acquires the immediately preceding detection time 601 associated with the document data file A from the time-series data identifying section 102 storing the immediately preceding detection times 601 associated with the respective notification target data files as shown in FIG. 6.

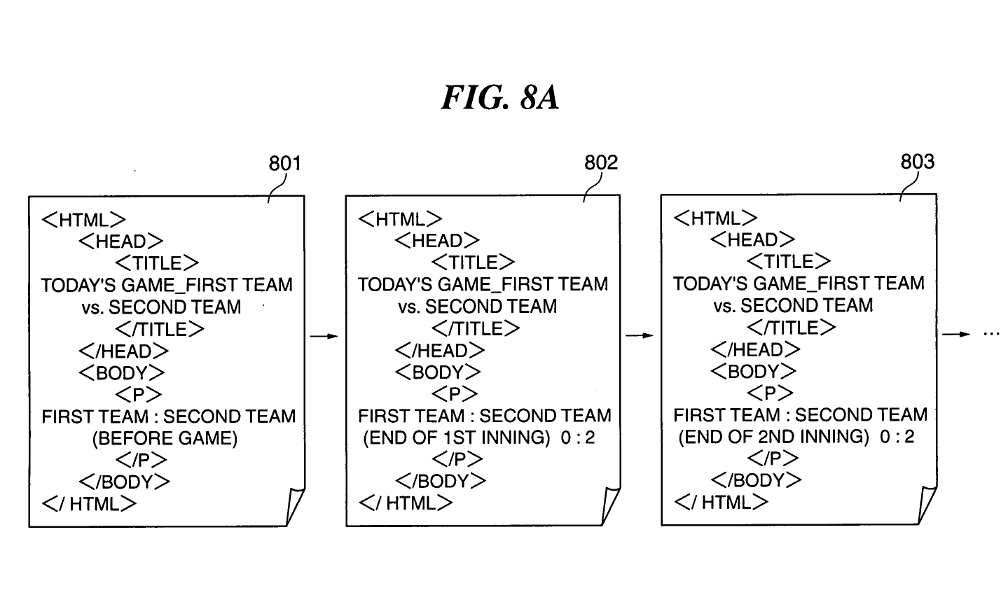

Then, in a step S303, the detecting section 103 acquires data (hereinafter referred to as “the immediately preceding time data) of the document data file A stored in the notification target data storage section 101 when a modification thereof was detected at the immediately preceding time of detection, based on the immediately preceding detection time 601 associated with the document data file A, which has been acquired in the step S302. At the same time, the detecting section 103 also acquires the latest data of the document data file A. Then, the detecting section 103 carries out comparison between the immediately preceding time data of the document data file A and the latest data of the same. In the present embodiment, the immediately preceding time data and the latest data of the document data file A are HTML document data files 701A and 701B, respectively (FIGS. 7A and 7B), and the detecting section 103 carries out the detection, based on the criterion (“whether or not a text portion except HTML tags has been modified (added, updated, or deleted)?”; hereinafter also referred to as “the update criterion”) 702 (FIG. 7C).

Then, it is determined in a step S304 whether or not the update criterion is satisfied by the detection carried out by the detecting section 103. If the answer to the question is affirmative (YES), the process proceeds to a step S305, whereas if the answer to the question is negative (NO), the process proceeds to a step S307. Therefore, when the detection is performed on the illustrated examples of the document data files 701A and 701B based on the criterion 702, the update criterion is satisfied, so that the process proceeds to the step S305.

In the step S305, the updated content extracting section 104 extracts an updated content satisfying the criterion. In the detection of the two data files shown in FIGS. 7A and 7B, the updated content 703 is as follows: (first team: second team (before game)→first team: second team (game over) 10:2) (FIG. 7D).

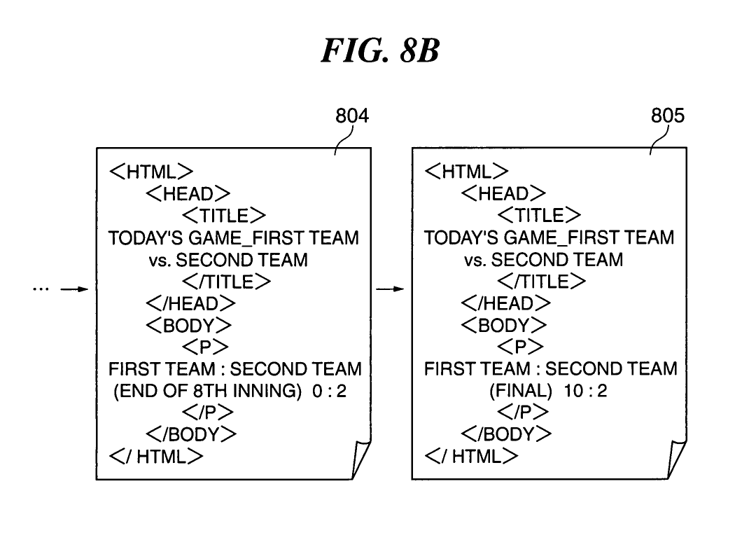

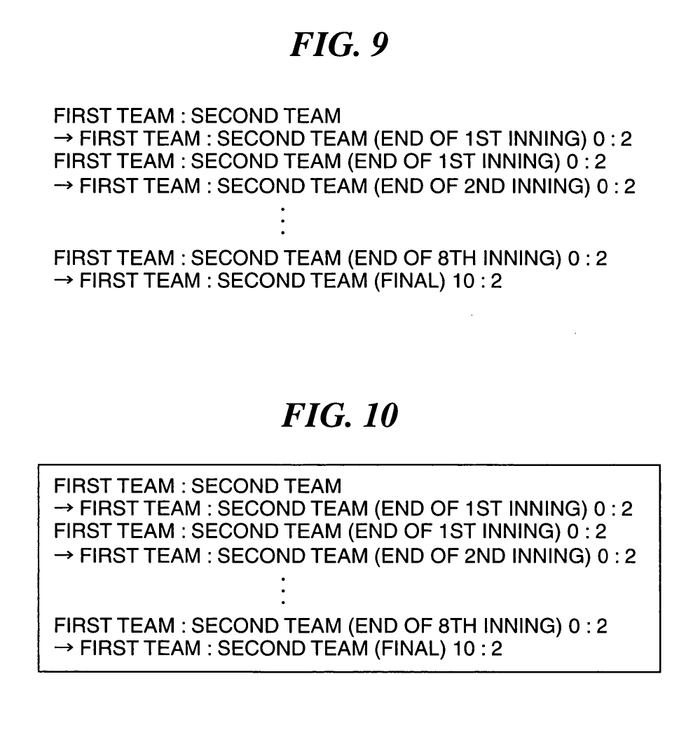

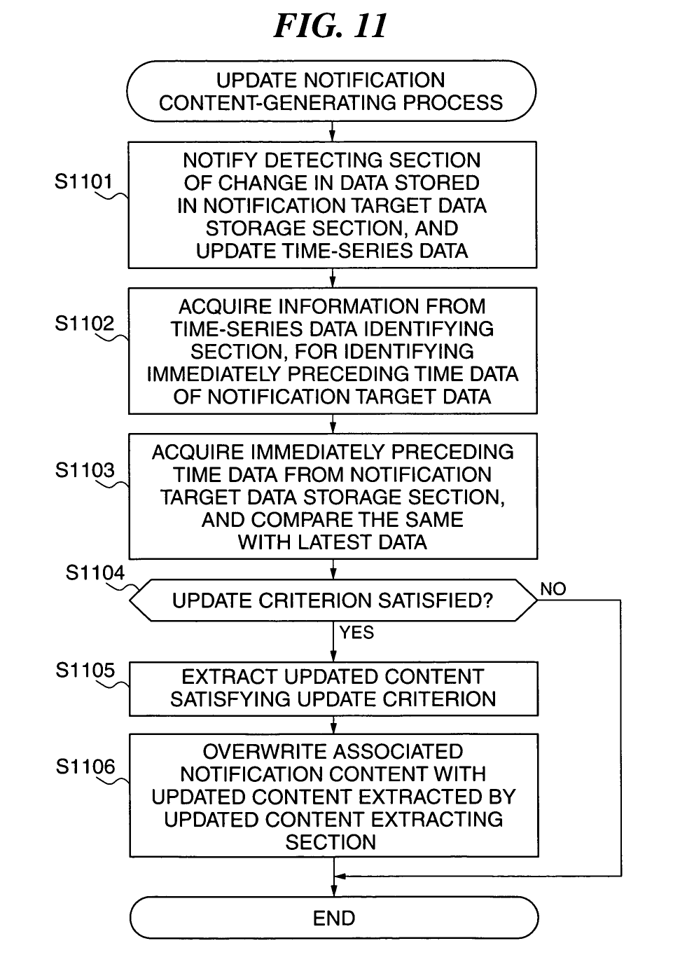

Then, in a step S306, the updated content extracted in the step S305 is stored in the notification content storage section 105. In the present embodiment, whenever an updated content is extracted, the updated content is added to a notification content associated therewith. For example, if the document data file A has been modified as in the examples 801 to 805 shown in FIGS. 8A and 8B between the immediately preceding notification and the present notification, the updated contents of the data file A are extracted as shown in FIG. 9. During this processing, whenever a new updated content is acquired, the notification content storage section 105 adds the updated content to the associated notification content as shown in FIG. 10 and stores the resulting notification content. This enables the notified party to know sequential changes in the updated content notified in a compiled form.

Then, in the step S307, the time-series data identifying section 102 updates the immediately preceding detection time 601 associated with the document data file A shown in FIG. 6 to the time the present detection has been executed.

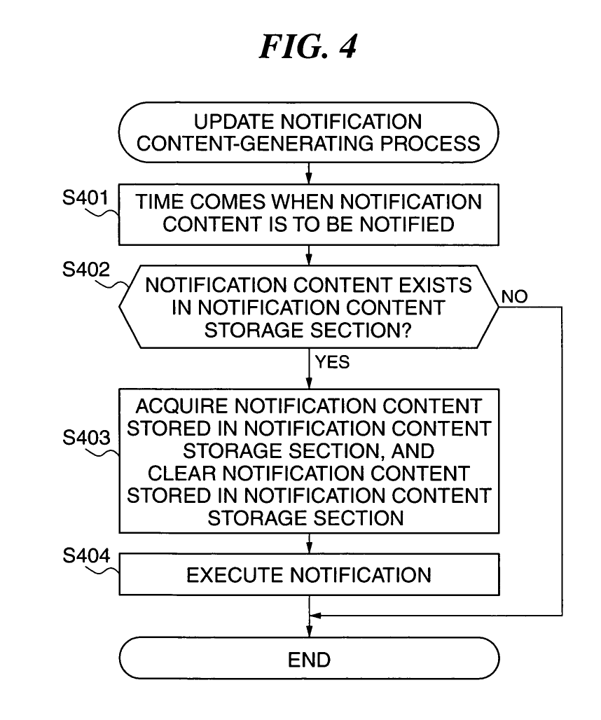

FIG. 4 is a flowchart showing an update notification content-notifying process carried out by the update notifying apparatus 1 shown in FIG. 1.

In FIG. 4, first, in a step S401, the time comes when the notifying section 106 notifies a certain notification content. In the present embodiment, it is assumed that the notifying section 106 is scheduled to periodically perform notification. However, the notification may be performed in a manner asynchronous with execution of the notification content-generating process shown in FIG. 3.

Then, in a step S402, the notification target data storage section 101 determines whether or not the notification content exists in the notification content storage section 105. If the answer to the question is affirmative (YES), the process proceeds to a step S403, whereas if the answer to the question is negative (NO), the present process is immediately terminated without executing the notification this time.

In the step S403, the notifying section 106 acquires the notification content stored in the notification content storage section 105, and clears the notification content stored in the notification content storage section 105.

Then, in a step S404, the notifying section 10.6 notifies the notified party of the notification content acquired in the step S403. Thus, the update notifying apparatus 1 need not execute the processing of comparison and detection at the time of notification, which contributes to reduction of processing load.

As described above, according to the update notifying method executed by the update notifying apparatus 1 of the present embodiment, updates of data are notified in a compiled form, so that it is possible to solve the problem that the frequent delivery of a plurality of data makes it difficult for the notified party to grasp the contents of notification. Further, reduction of notification frequency makes it possible to suppress the increase in traffic on the network. Furthermore, it is possible to reduce the amount of processing executed at the time of notification, thereby reducing the notifying time lag. Moreover, since contents updated between the immediately preceding notification and the present notification are compiled and added to the notification content, the notified party can recognize the history of the updated contents.

Next, a description will be given of a variation of the update notifying method executed by the update notifying apparatus 1.

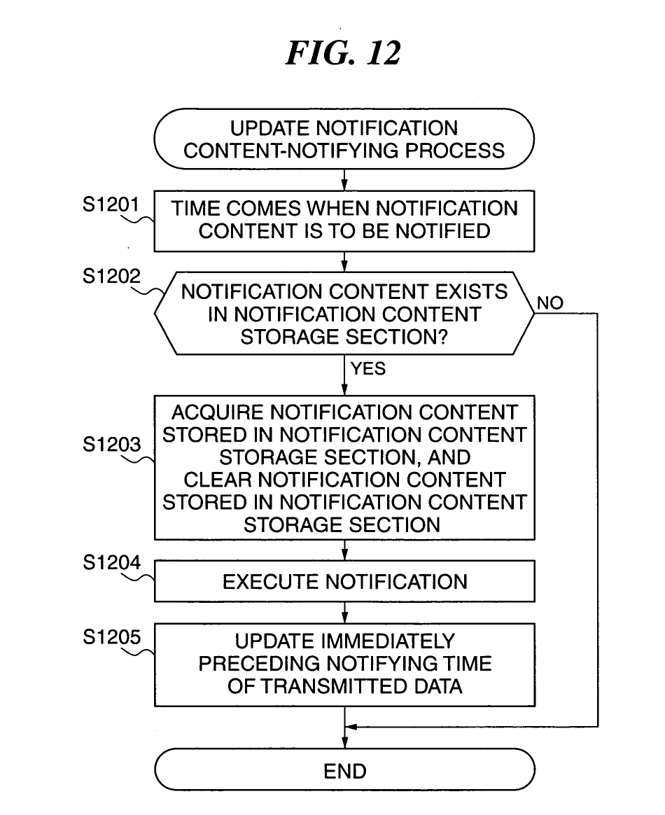

FIG. 11 is a flowchart showing a variation of the update notification content-generating process carried out by the update notifying apparatus shown 1 in FIG. 1. The present process is executed by the CPU 204 according to a control program stored in the ROM 202.

In FIG. 11, first, in a step S1101, the notification target data-storage section 101 notifies the detecting section 103 that a notification target data file stored in the section 101 has been modified, and then updates time-series data stored therein. In the present variation as well, it is assumed that the notification target data storage section 101 stores a document data file A and time-series data 501 associated therewith, as the notification target data, as shown in FIG. 5, and when a new document data file A is acquired, the section 101 detects that the notification target data file has been modified, and updates the time-series data 501, using detection time information 502 therefor.

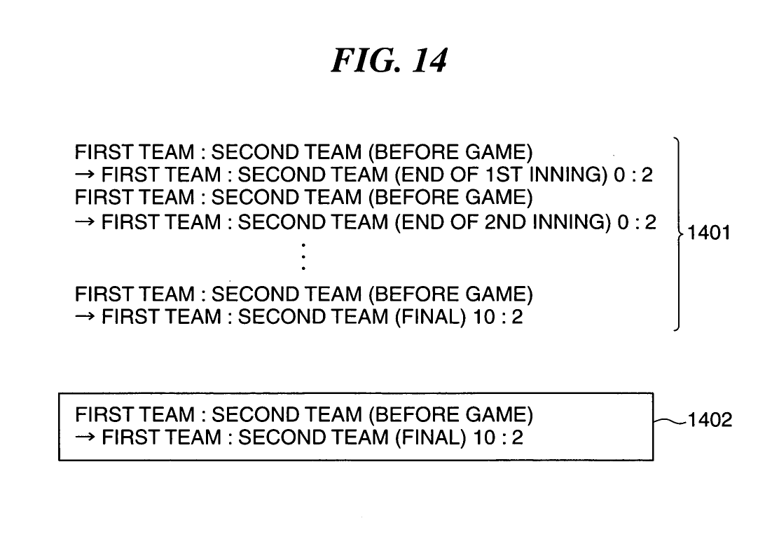

Then, in a step S1102, the detecting section 103, upon being notified of the modification of the document data file A by the notification target data storage section 101, acquires the immediately preceding notifying time 1301 associated with the document data file A from the time-series data identifying section 102 storing the immediately preceding notifying times 1301 associated with the respective notification target data files as shown in FIG. 13.

Then, in a step S1103, the detecting section 103 acquires data (hereinafter referred to as “notifying time data”) of the document data file A stored in the notification target data storage section 101 at the time of the immediately preceding notification, based on the immediately preceding notifying time 1301 associated with the document data file A, which is acquired in the step S1102. At the same time, the detecting section 103 also acquires the latest data of the document data file A. Then, the detecting section 103 carries out comparison between the immediately preceding notifying time data of the document data file A and the latest data of the same. In the present variation as well, the immediately preceding notifying time data and the latest data of the document data file A are HTML document data files 701A and 701B (FIGS. 7A and 7B), and the detecting section 103 carries out the detection based on the criterion (“whether or not a text portion except HTML tags has been modified (added, updated, or deleted)?”) 702 (FIG. 7C).

Then, it is determined in a step S1104 whether or not the update criterion is satisfied by the detection carried out by the detecting section 103. If the answer to the question is affirmative (YES), the process proceeds to a step S1105, whereas if the answer to the question is negative (NO), the process is immediately terminated. Therefore, when the detection is performed on the illustrated examples of the document data files 701A and 701B based on the criterion 702, the update criterion is satisfied, so that the process proceeds to the step S1105.

In the step S1105, the updated content extracting section 104 extracts an updated content satisfying the criterion. In the detection of the two data files shown in FIGS. 7A and 7B, the updated content 703 is as follows: (first team: second team (before game)→first team: second team (game over) 10:2) (FIG. 7D).

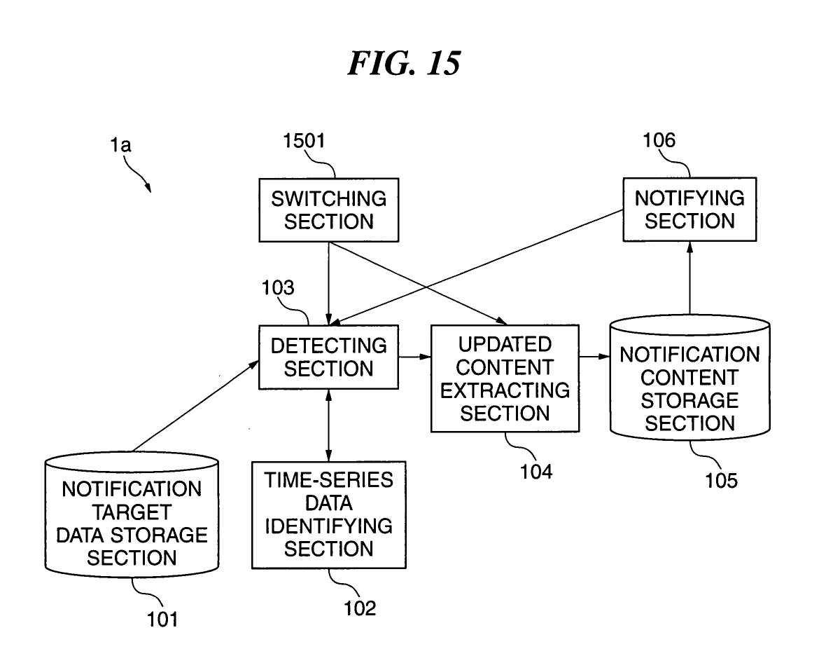

Then, in a step S1106, the updated content extracted in the step S1105 is stored in the notification content storage section 105. In the present variation, whenever an updated content is extracted, the associated notification content is overwritten with the extracted updated content. For example, if the document data file A has been modified as in the examples 801 to 805 shown in FIGS. 8A and 8B between the immediately preceding notification and the present notification, the updated contents associated with the data file A are extracted as an example 1401 shown in FIG. 14. During this processing, whenever a new updated content is acquired, the notification content storage section 105 overwrites the associated notification content with the updated content, and the updated content 1402 (FIG. 14) from the immediately preceding notifying time data is always stored, followed by terminating the present process.

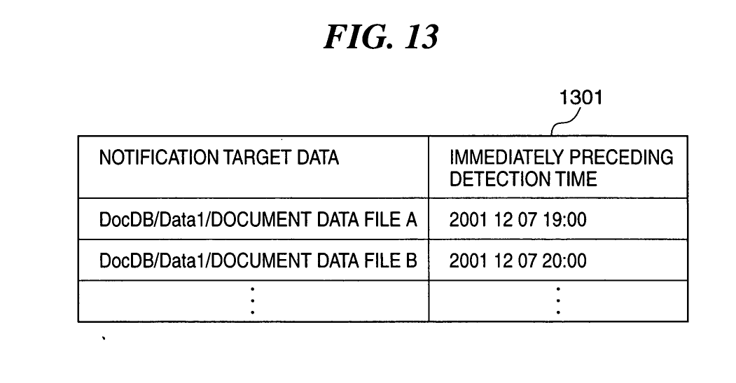

FIG. 12 is a flowchart showing a variation of the update notification content-notifying process carried out by the update notifying apparatus 1 shown in FIG. 1 according to the present embodiment.

In FIG. 12, first, in a step S1201, the time comes when the notifying section 106 notifies a certain notification content. In the present variation, it is assumed that the notifying section 106 is scheduled to periodically perform notification. However, the notification may be performed in a manner asynchronous with execution of the notification content-generating process shown in FIG. 11.

Then, in a step S1202, the notification target data storage section 101 determines whether or not the notification content exists in the notification content storage section 105. If the answer to the question is affirmative (YES), the process proceeds to a step S1203, whereas if the answer to the question is negative (NO), the present process is immediately terminated without executing the notification this time.

In the step S1203, the notifying section 106 acquires the notification content stored in the notification content storage section 105, and clears the notification content stored in the notification content storage section 105.

Then, in a step S1204, the notifying section 106 notifies the notified party of the notification content acquired in the step S1203. Thus, the update notifying apparatus 1 need not execute the processing of comparison and detection at the time of notification, which contributes to reduction of processing load.

Then, in a step S1205, the notifying section 106 notifies the detecting section 103 of the time the present notification process was executed, and the detecting section 103 causes the time-series data identifying section 102 to update the immediately preceding notifying time associated with the time-series data, followed by terminating the present process.

As described above, according to the variation of the update notifying method executed by the update notifying apparatus of the present embodiment, the difference between the immediately preceding notifying time data and the latest data is extracted and stored as the updated content, so that a user can easily know how the data has been updated, when he/she desires.

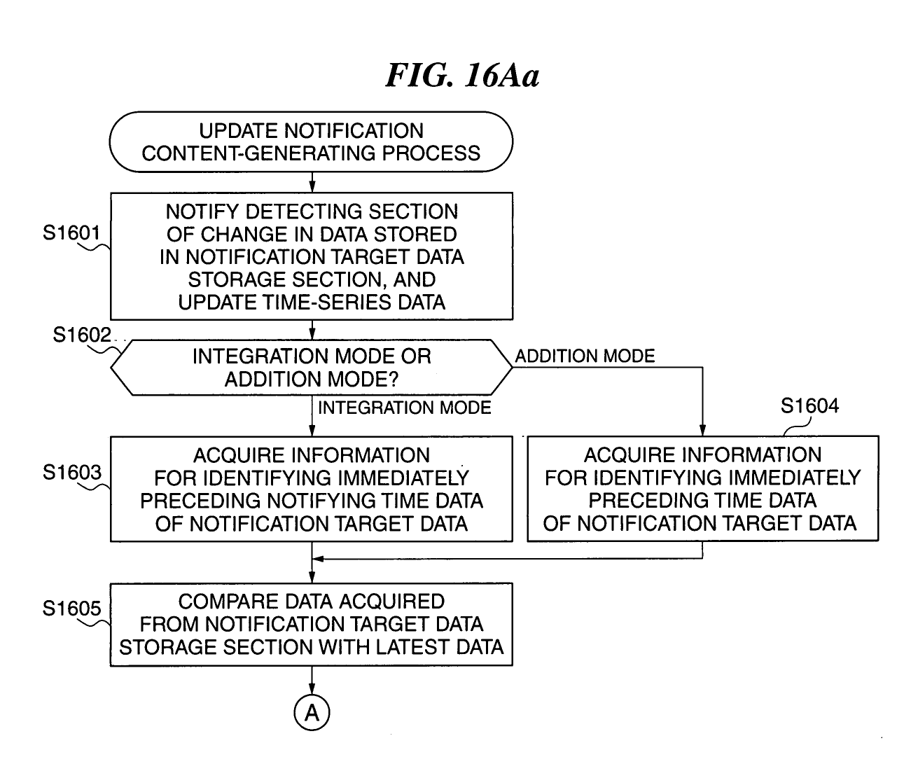

Next, a second embodiment of the present invention will be described with reference to FIGS. 15 to 17.

The present embodiment can switch between the notifying method used in the first embodiment described above (hereinafter referred to as “the addition mode”) and the notifying method used in the variation thereof described above (hereinafter referred to as “the integration mode”).

FIG. 15 is a block diagram showing the basic arrangement of an update notifying apparatus 1a according to the present embodiment.

As shown in FIG. 15, the update notifying apparatus 1a of the present embodiment is basically identical in construction to the update notifying apparatus 1 shown in FIG. 1, except that a switching section 1501 is additionally provided. Therefore, like sections are designated by like reference numerals, and duplicate description thereof is omitted.

In the present embodiment, the time-series data identifying section 102 stores the time the immediately preceding detection of each data file was performed, in addition to the information stored in the first embodiment. The notification content storage section 105 is capable of adding an updated content to a notification content whenever the update content is extracted, and then storing the resulting notification content, as in the case of the update notification content-generating process (FIG. 3) in the first embodiment, and also capable of overwriting the notification content with the updated content and storing the resulting notification content as in the case of the update notification content-generating process (FIG. 11) in the variation of the first embodiment.

The switching section 1501 switchably sets the update notifying apparatus la to one of the addition mode where the latest data is compared with the immediately preceding time data and the integration mode where the latest data is compared with the immediately preceding notifying time data. Further, when the update notifying apparatus 1a is set to the integration mode by the switching section 1501, the updated content extracting section 104 extracts an updated content by comparison between the immediately preceding notifying time data and the latest data, and the notification content storage section 105 overwrites the associated notification content with the updated content and stores the resulting notification content. On the other hand, when the update notifying apparatus 1a is set to the addition mode by the switching section 1501, the updated content extracting section 104 extracts an updated content by comparison between the immediately preceding time data and the latest data, and the notification content storage section 105 adds the updated content to the associated notification content and stores the resulting notification content.

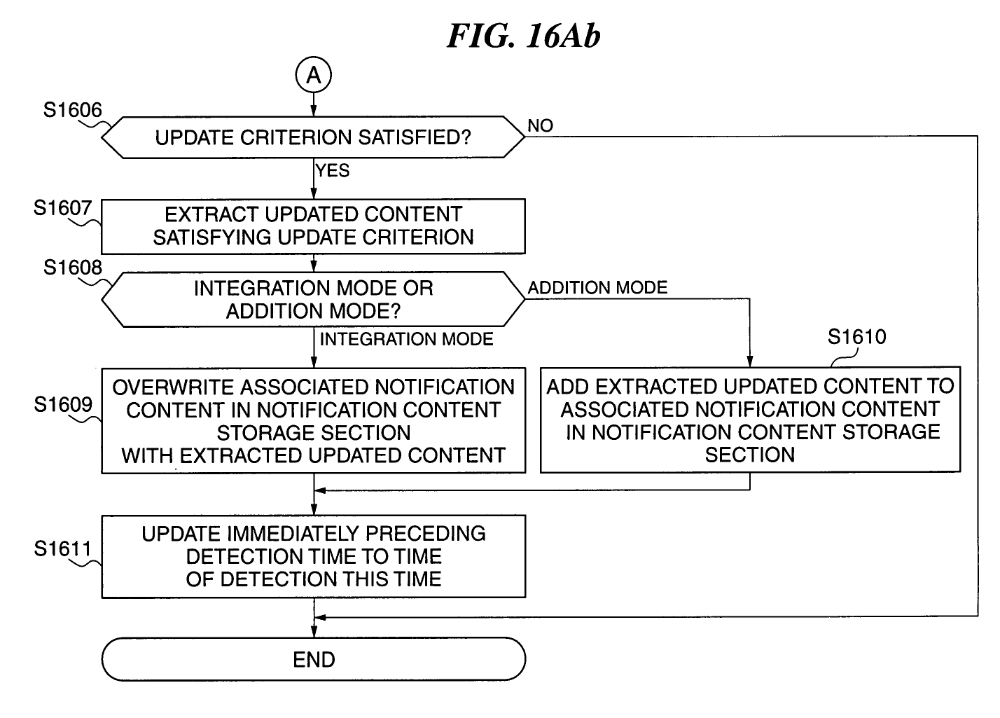

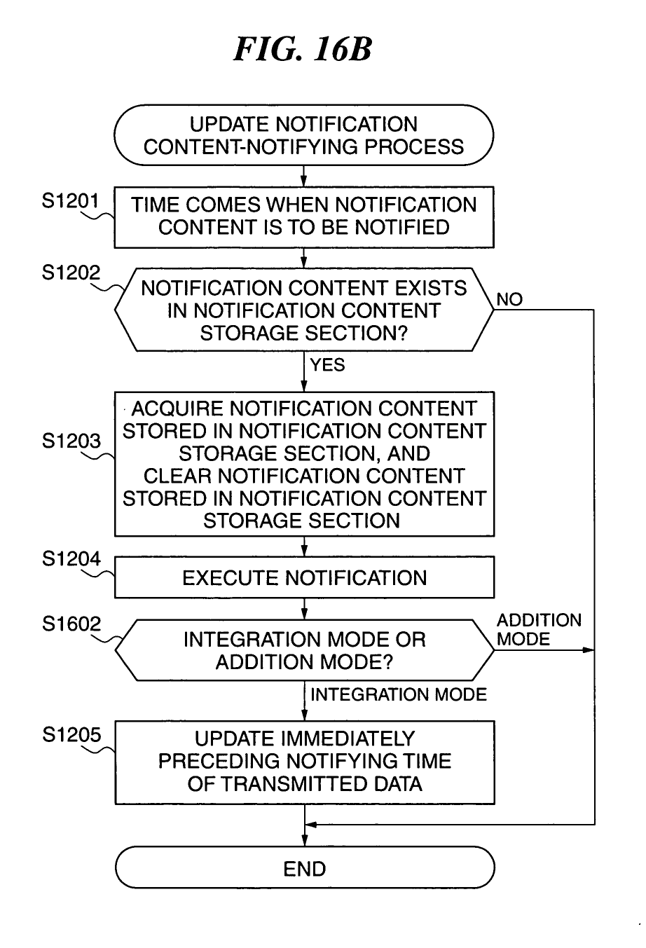

FIGS. 16Aa and 16Ab are flowchart showing an update notification content-generating process carried out by the update notifying apparatus 1a according to the present embodiment. The present process is executed by the CPU 204 according to a control program stored in the ROM 202.

In FIG. 16Aa, first, in a step S1601, the notification target data storage section 101 notifies the detecting section 103 that a notification target data file stored in the section 101 has been modified, and updates time-series data also stored therein.

Then, it is determined in a step S1602 which of the addition mode and the integration mode has been selected by the switching section 1501. If the integration mode has been selected, the process proceeds to a step S1603, whereas if the addition mode has been selected, the process proceeds to a step S1604.

In the step S1603, the detecting section 103, upon being notified by the notification target data storage section 101 that the document data file A has been modified, acquires the immediately preceding notifying time 1301 (FIG. 13) associated with the data file A from the time-series data identifying section 102.

In the step S1604, the detecting section 103, upon being notified by the notification target data storage section 101 that the document data file A has been modified, acquires the immediately preceding detection time 601 (FIG. 6) associated with the data file A from the time-series data identifying section 102.

After execution of the step S1603 or S1604, the process proceeds to a step S1605.

In the step S1605, the detecting section 103 acquires the immediately preceding notifying time (or detection-time) data of the document data file A stored in the notification target data storage section 101, based on the immediately preceding notifying time 1301 (or the immediately preceding detection time 601). At the same time, the detecting section 103 also acquires the latest data of the document data file A. Then, the detecting section 103 carries out comparison between the immediately preceding notifying time (or detection-time) data of the document data file A and the latest data of the same, followed by the process proceeding to the following step S1606.

In the step S1606, it is determined whether or not the update criterion is satisfied by the detection carried out by the detecting section 103. If the answer to the question is affirmative (YES), the process proceeds to a step S1607, whereas if the answer to the question is negative (NO), the present process is immediately terminated.

In the step S1607, the updated content extracting section 104 extracts an updated content which satisfies the update criterion.

Then, it is determined in a step S1608 which of the addition mode and the integration mode has been selected by the switching section 1501. If the integration mode has been selected, the process proceeds to a step S1609, whereas if the addition mode has been selected, the process proceeds to a step S1610.

In the step S1609, the updated content extracted in the step S1607 is stored in the notification content storage section 105.

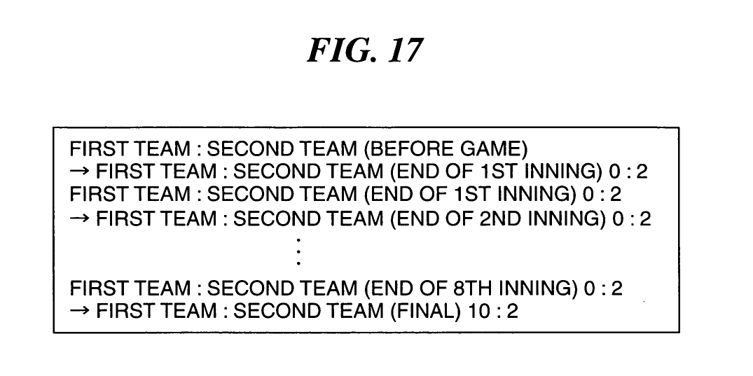

In the step S1610, the extracted updated content is stored in the notification content storage section 105. In this step, whenever an updated content is extracted, the updated content is added to the associated notification content. For example, if the document data file A has been modified as in the examples 801 to 805 shown in FIGS. 8A and 8B between the immediately preceding notification and the present notification, the updated contents of the data file A are extracted as the example 1401 shown in FIG. 14. During this processing, whenever a new updated content is acquired, the notification content storage section 105 adds the updated content to the associated notification content as shown in FIG. 17, and stores the resulting notification content.

After execution of the step S1609 or S1610, the process proceeds to a step S1611.

In the step S1611, the immediately preceding detection time stored in the time-series data identifying section 102 is updated to the present detection time, followed by terminating the present process.

It should be noted that, as shown in FIG. 16B, an update notification content-notifying process executed by the update notifying apparatus 1a according to the present embodiment is identical to the update notification content-notifying process shown in FIG. 12 and executed in the variation of the first embodiment, except that a determination step (step S1602) of determining which of the integration mode and the addition mode has been selected is inserted between a step S1204 and a step S1205. Therefore, like steps are designated by like step numbers, and description thereof is omitted.

As described above, according to the update notifying method executed by the update notifying apparatus 1a of the present embodiment, it is possible to switch between the addition mode and the integration mode simply by additionally providing the switching section 1501. Further, since the switching between the addition mode and the integration mode is possible, the notified party can select either of the two modes depending on information desired to be sent.

Although in the above-described embodiments and the variation, it is assumed that the timing for notification in the step S401 in FIG. 4 and that in the step S1201 in FIG. 12 are scheduled by the notifying section 106, this is not limitative, but the notified party may schedule timing for notification as desired. Alternatively, the notification content storage section 105 may cause the notifying section 106 to send a notification content in timing in which the notification content is updated.

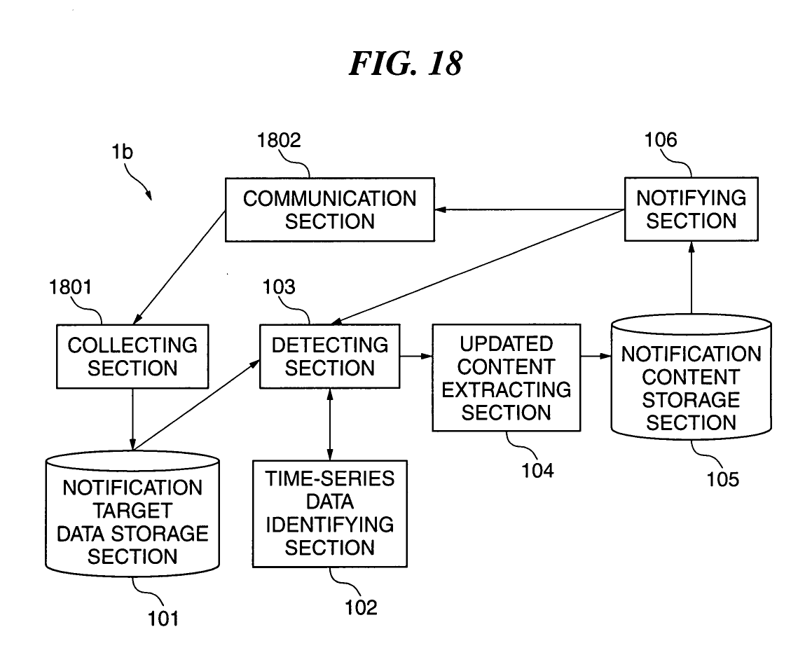

Next, a third embodiment of the present invention will be described with reference to FIGS. 18 to 20.

Although in the above-described first and second embodiments, notification target data files exist on the same computer, in the present embodiment, a communication section and a collecting section are added to the arrangement of the first embodiment shown in FIG. 1 or that of the second embodiment shown in FIG. 15 so as to collect arbitrary data files existing in other computers on the network and store the collected data in the notification target data storage section.

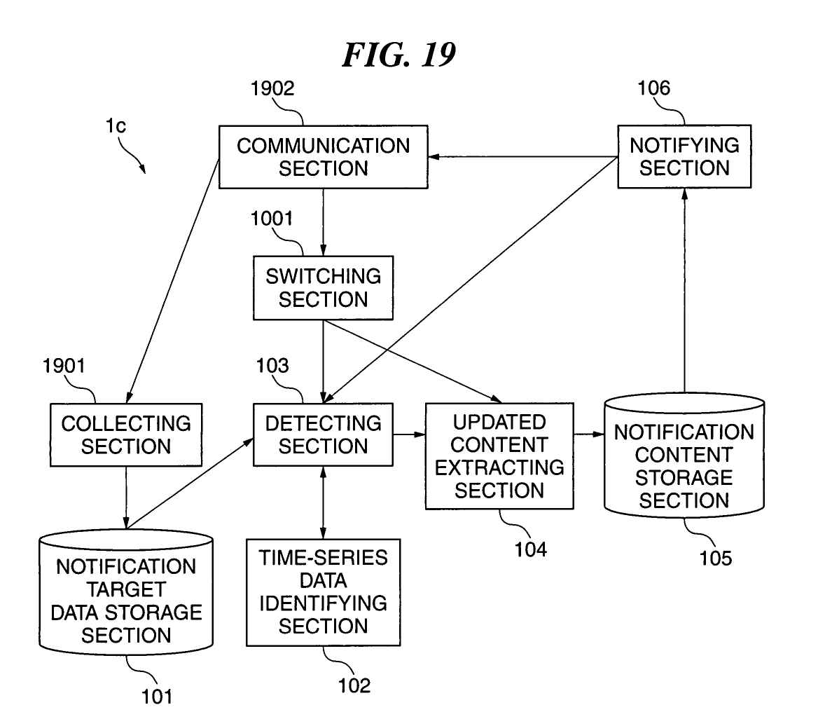

FIGS. 18 and 19 are block diagrams showing the basic arrangement of one form 1b of an update notifying apparatus and that of another form 1c of the same, according to the present embodiment.

Since the update notifying apparatuses 1b and 1c are basically identical in arrangement to the apparatuses shown in FIGS. 1 and 15 except that the collecting sections 1801 and 1901 and communication sections 1802 and 1902 are additionally provided, respectively, like sections are designated by like reference numerals, and duplicate description thereof is omitted.

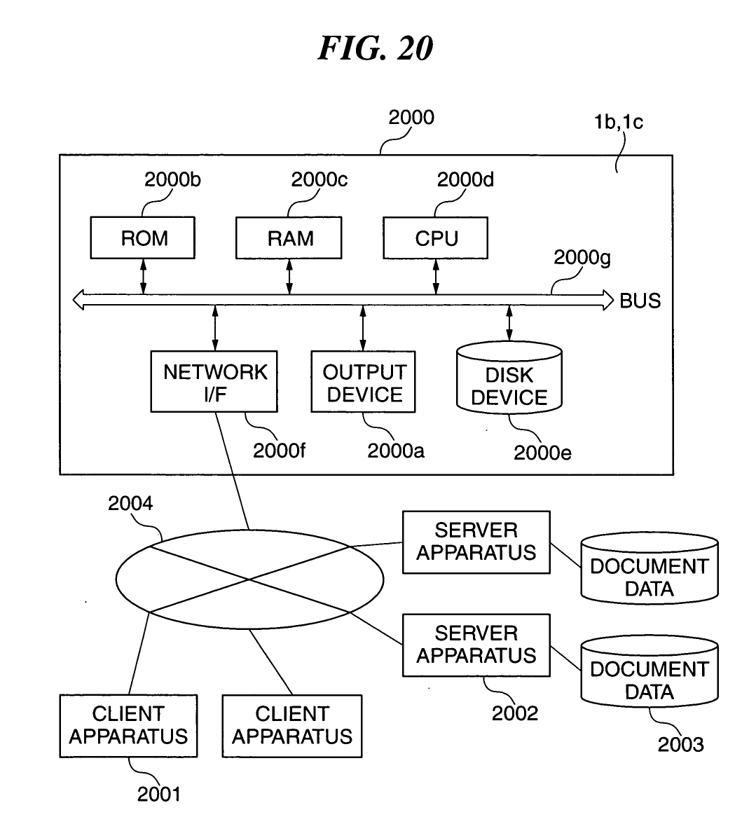

FIG. 20 is a block diagram showing the basic arrangement of a communication system including the update notifying apparatus 1b (1c) in FIGS. 18 and 19.

As shown in FIG. 20, the communication system is comprised of an update notifying apparatus 2000 (update notifying apparatus 1b (1c)), client apparatuses 2001, server apparatuses 2002, document data files 2003, and a network 2004.

The update notifying apparatus 2000 is comprised of an output device 2000a, a ROM (Read only Memory) 2000b, a RAM (Random Access Memory) 2000c, a CPU (Central Processing Unit) 2000d, a disk device 2000e, and a network interface (network I/F) 2000f, all of which are interconnected via a bus 2000g.

The collecting section 1901 (1801) collects requests from notified parties using other computers on the network 2004, via the communication section 1902 (1802), and transmits the requests to the notification target data storage section 101. Further, the communication section 1902 (1802) sends notification from the notifying section 106 to other computers on the network 2004 by E-mail, for example.

Although in the first embodiment or the variation thereof, when there exists no notification content, the process is immediately terminated without executing notification, this is not limitative, but a message indicating that there is no notification content may be formed and transmitted.

Although in the above embodiments and variation, a text portion of a document data file is regarded as a detection target, this is not limitative, but when the detecting section 103 detects binary data as a detection target, for example, and whether or not there is a difference between two binary data files is employed as the aforementioned update criterion, it is possible to regard data other than document data files as notification target data.

Although in the above-described embodiments and variation, time-series data stored in the notification storage section 101 contains time information, and the time information is used to identify past data files, this is not limitative, but each past data file may be identified by a unique ID (identifier) added thereto. In this case, a data file is stored in the time-series data identifying section 102, not with time information, but with an ID number associated with the data file.

Although in the above-described embodiments and variation, updated contents of a single notification target data file are compiled as a notification content stored in the notification content storage section 105, this is not limitative, but updated contents of a plurality of notification target data files may be compiled as the notification content.

In the above-described embodiments and variation, the notification content storage section 105 may store different notification contents provided, respectively, for a plurality of notified parties as described hereinabove. In this case, there is a possibility of an updated content of the same data file being sent to different notified parties in different timings, which makes it impossible to uniquely determine the immediately preceding notifying time of the updated content. Therefore, the time-series data identifying section 102 manages information for identifying immediately preceding notifying times on a notification content-by-notification content basis.

Although in the above-described embodiments and variation, the notification target data storage section 101 stores past data as time-series data without processing the same, this is not limitative, but time-series data has only to be data capable of reproducing past data, and therefore differences between data files may be stored as a history of past data.

Further, although in the above-described embodiments and variation, the various sections described above are implemented by the same computer, this is not limitative, but computers, processors, and the like, dispersed on a network, may perform the functions of the respective sections.

Moreover, although in the above-described embodiments and variation, the program is stored in the ROM, this is not limitative, but an arbitrary storage medium may be used for storing the program. Alternatively, the program may be realized by a circuit capable of performing the same operation.

The present invention may either be applied to a system composed of a plurality of apparatuses or to a single apparatus.

It is to be understood that the object of the present invention may also be accomplished by supplying a system or an apparatus with a storage medium in which a program code of software which realizes the functions of the above described embodiment and variation is stored, and causing a computer (or CPU or MPU) of the system or apparatus to read out and execute the program code stored in the storage medium.

In this case, the program code itself read from the storage medium realizes the functions of any of the embodiments and variation described above, and therefore the program code and the storage medium in which the program code is stored constitute the present invention.

Examples of the storage medium for supplying the program code include a floppy (registered trademark) disk, a hard disk, an optical disk, a magnetic-optical disk, a CD-ROM, a CD-R, a CD-RW, a DVD-ROM, a DVD-RAM, a DVD−RW, or a DVD+RW, a magnetic tape, a nonvolatile memory card, and a ROM. Alternatively, the program may be downloaded via a network from another computer, a database, or the like, not shown, connected to the Internet, a commercial network, a local area network, or the like.

Further, it is to be understood that the functions of the above-described embodiments and variation may be accomplished not only by executing a program code read out by a computer, but also by causing an OS (operating system) or the like which operates on the computer to perform a part or all of the actual operations based on instructions of the program code.

Further, it is to be understood that the functions of the above-described embodiments and variation may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

The above described embodiments and variation are given as illustrative only of the principles of the present invention, since the spirit and scope of the present invention are not limited to the specific embodiments and variation thereof, and all suitable modifications and equivalents may be regarded as falling within the scope of the invention as defined in the appended claims.

1. A method of notifying updates of data, comprising:
a detecting step of detecting update of data;
a storing step of storing an update content which indicates a difference between the data before and after the update;
a notifying step of notifying a plurality of update contents stored in said storing step in a predetermined form.

2. A method as claimed in claim 1, wherein said notifying step comprises notifying the plurality of update contents in a form arranged in order in which the update of the data is detected.

3. A method as claimed in claim 1, wherein said notifying step comprises notifying the plurality of update contents stored in the storing step after notifying last time.

4. A method as claimed in claim 1, wherein the update content includes at least states before and after update of updated part of the data.

5. A method as claimed in claim 1, wherein said storing step comprises storing the update content in a case where the update satisfies a predetermined criterion.

6. A method as claimed in claim 1, wherein timing for notification in said notifying step is externally designated.

7. A method as claimed in claim 1, wherein timing for notification in said notifying step is scheduled in advance.

8. A method as claimed in claim 1, further comprising:
an update criterion-setting step of setting an update criterion to be applied in notifying a notified party of the updated contents; and
an extracting step of extracting a portion of latest updated data satisfying the update criterion set in said update criterion-setting step, as the updated content.

9. A method of notifying updates of data, comprising:
a detecting step of detecting update of data;
a notifying step of notifying an update content which indicates a difference between updated data detected in said detecting step and data obtained from storing means;
a storing step of storing at least the updated data corresponding to the update content notified last time in said notifying step in the storing means;
wherein said notifying step comprises notifying an update content which indicates a difference between the updated data detected in said detecting step and the updated data stored in said storing step.

10. An update notifying apparatus comprising:
a detecting device that detects update of data;
a storing device that stores an update content which indicates a difference between the data before and after the update;
a notifying device that notifies a plurality of update contents stored in said storing step in a predetermined form.

11. An update notifying apparatus comprising:
a detecting means for detecting update of data;
a storing means for storing an update content which indicates a difference between the data before and after the update;
a notifying means for notifying a plurality of update contents stored in said storing step in a predetermined form.

12. A program for causing a computer to execute an update notifying method, comprising:
a detecting module for detecting update of data;
a storing module for storing an update content which indicates a difference between the data before and after update;
a notifying module for notifying a plurality of update contents stored in said storing step in a predetermined form.
